(19) United States
(12) Patent Application Publication
(10) Pub. No.: US 2018/0102143 A1
(43) Pub. Date: Apr. 12, 2018

(54) MODIFICATION OF MEDIA CREATION TECHNIQUES AND CAMERA BEHAVIOR BASED ON SENSOR-DRIVEN EVENTS

(71) Applicant: LR Acquisition, LLC, New York, NY (US)

(72) Inventors: James W. Allison, Carmel Valley, CA (US); Henry W. Bradlow, San Francisco, CA (US); Gillian C. Langor, Oakland, CA (US); Antoine Balaresque, Sausalito, CA (US)

(73) Assignee: LR Acquisition, LLC, New York, NY (US)

(21) Appl. No.: 15/729,840

(22) Filed: Oct. 11, 2017

Related U.S. Application Data
(60) Provisional application No. 62/407,076, filed on Oct. 12, 2016.

(51) Int. Cl. G11B 27/036; H04N 9/802; H04N 21/45; H04N 21/4402; H04N 21/4223; H04N 21/4788; H04N 21/472; G06K 9/00

(52) U.S. Cl. CPC G11B 27/036; H04N 9/802; H04N 21/4524; H04N 21/440263; B64C 39/024; H04N 21/4788; H04N 21/47205; G06K 9/00765; G06K 2009/00738; H04N 21/4223

(57) ABSTRACT

Introduced herein are systems and techniques for automatically producing media content (e.g., a video composition) using several inputs uploaded by an unmanned aerial vehicle (UAV) copter, an operator device, and/or some other computing device. More specifically, production and modification techniques based on sensor-driven events are described herein that allow videos to be created on behalf of a user of the UAV copter. Interesting segments of raw video recorded by the UAV copter can be formed into a video composition based on sensor events that are indicative of interesting real world events. The sensors responsible for detecting the events may be connected to (or housed within) the UAV copter, the operator device, and/or some other computing device. Sensor measurements can also be used to modify the positioning, movement pattern, focus level/point, etc., of the UAV copter responsible for generating the raw video.

### CROSS-REFERENCE TO RELATED APPLICATION

This application claims priority to U.S. Provisional Patent Application No. 62/407,076, filed Oct. 12, 2016, the entire contents of which are herein incorporated by reference in their entirety.

### RELATED FIELD

At least one embodiment of this disclosure relates generally to techniques for filming, producing, editing/modifying, and/or presenting media content using data created by one or more non-visual sensors.

### BACKGROUND

Video production is the process of creating video by capturing moving images, and then creating combinations and reductions of parts of the video in live production and post-production. Finished video productions range in size and can include, for example, television programs, television commercials, corporate videos, event videos, etc. The type of recording device used to capture video often changes based on the intended quality of the finished video production. For example, one individual may use a mobile phone to record a short video clip that will be uploaded to social media (e.g., Facebook or Instagram), while another individual may use a multiple-camera setup to shoot a professional-grade video clip.

Video editing software is often used to handle the post-production video editing of digital video sequences. Video editing software typically offers a range of tools for trimming, splicing, cutting, and arranging video recordings (also referred to as “video clips”) across a timeline. Examples of video editing software include Adobe Premiere Pro, Final Cut Pro X, iMovie, etc. However, video editing software may be difficult to use, particularly for those individuals who capture video using a personal computing device (e.g., a mobile phone) and only intend to upload the video to social media or retain it for personal use.

### BRIEF DESCRIPTION OF THE DRAWINGS

Various objects, features, and characteristics will become apparent to those skilled in the art from a study of the Detailed Description in conjunction with the appended claims and drawings, all of which form a part of this specification. While the accompanying drawings include illustrations of various embodiments, the drawings are not intended to limit the claimed subject matter.

FIG. 1 is an example of a UAV copter, in accordance with various embodiments.

FIG. 2 is a block diagram of a UAV copter, in accordance with various embodiments.

FIG. 3 is a block diagram of an operator device of a UAV copter, in accordance with various embodiments.

FIG. 4 depicts a diagram of an environment that includes a network-accessible platform that is communicatively coupled to a UAV copter, operator device, and/or some other computing device associated with the owner/user of the UAV copter.

FIG. 5 depicts a flow diagram of a process 500 for automatically producing media content (e.g., a video composition) using several inputs, in accordance with various embodiments.

FIG. 6 depicts one example of a process for automatically producing media content (e.g., a video composition) using inputs from several distinct computing devices, in accordance with various embodiments.

FIG. 7 is a block diagram of an example of a computing device, which may represent one or more computing device or servers described herein, in accordance with various embodiments.

The figures depict various embodiments described throughout the Detailed Description for the purposes of illustration only. While specific embodiments have been shown by way of example in the drawings and are described in detail below, one skilled in the art will readily recognize the subject matter is amenable to various modifications and alternative forms without departing from the principles of the invention described herein. Accordingly, the claimed subject matter is intended to cover all modifications, equivalents, and alternatives falling within the scope of the invention as defined by the appended claims.

### DETAILED DESCRIPTION

Introduced herein are systems and techniques for automatically producing media content (e.g., a video composition) using several inputs uploaded by an unmanned aerial vehicle (UAV) copter, an operator device, and/or some other computing device (e.g., a mobile phone associated with the owner/user of the UAV copter). More specifically, production and modification techniques based on sensor-driven events are described herein that allow videos to be created on behalf of a user of the UAV copter. Interesting segments of video recorded by the UAV copter can be formed into a video composition based on sensor events that are indicative of an interesting real world event. For example, interesting segments of video can be identified based on large changes in acceleration as detected by an accelerometer or large changes in elevation as detected by a barometer. The accelerometer and barometer may be connected to (or housed within) the UAV copter, the operator device, and/or some other computing device.

Video compositions (and other media content) can be created using different “composition recipes” that specify an appropriate style or mood and that allow video content to be timed to match audio content (e.g., music and sound effects). While the “composition recipes” allow videos to be automatically created (e.g., by a network-accessible platform or computing device, such as a mobile phone, tablet, or personal computer), some embodiments enable additional levels of user input. For example, an editor may be able to reorder or discard certain segments, select different raw video clips, and use video editing tools to modify color, warping, stabilization, etc.

Also introduced herein are techniques for modifying filming characteristics or flight parameters of the UAV copter based on the sensor events. For example, sensor measurements may prompt changes to be made to the positioning, orientation, or movement pattern of the UAV copter. As another example, sensor measurements may cause the UAV copter to modify its filming technique (e.g., by changing the resolution, focal point, etc.). Accordingly, the UAV copter (or some other computing device) may continually or periodically monitor the sensor measurements to determine whether they exceed an upper threshold value, fall below a lower threshold value, or exceed a certain variation in a specified time period.

### Terminology

Brief definitions of terms, abbreviations, and phrases used throughout this disclosure are given below.

As used herein, the terms “connected,” “coupled,” or any variant thereof, means any connection or coupling, either direct or indirect, between two or more elements; the coupling of connection between the elements can be physical, logical, or a combination thereof. For example, two components may be coupled directly to one another or via one or more intermediary channels or components. Additionally, the words “herein,” “above,” “below,” and words of similar import shall refer to this application as a whole and not to any particular portions of this application.

### System Topology Overview

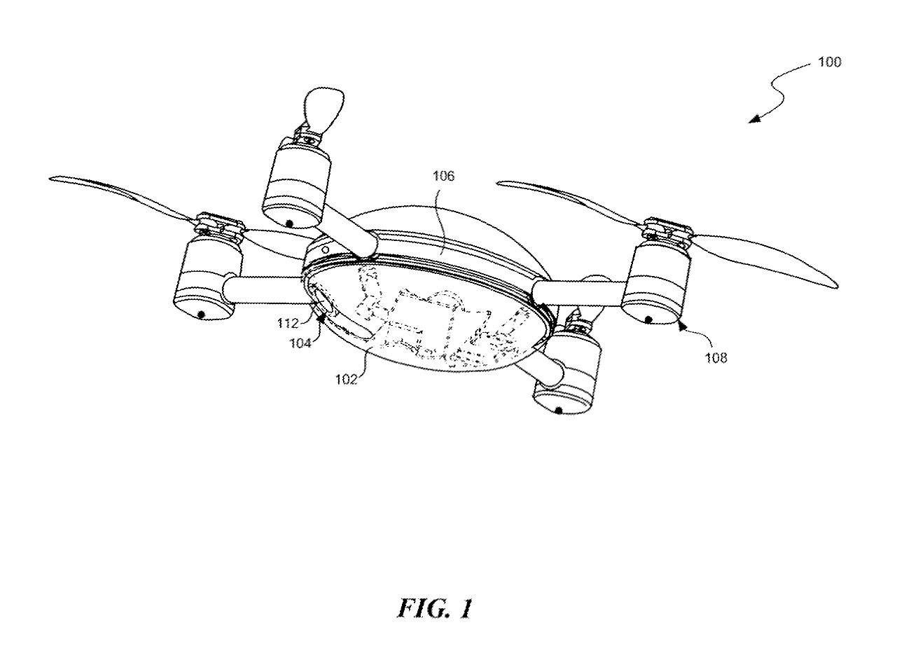

FIG. 1 is an example of an unmanned aerial vehicle (UAV) copter 100 (also referred to as a “drone”), in accordance with various embodiments. The UAV copter 100 includes a bottom cover 102 (where the interior components are shown with dashed lines), a sensor compartment 104, a support structure 106 (including an internal frame and an external shell), and one or more propeller drivers 108. The sensor compartment 104 is adapted to store one or more sensors 112, such as a photo camera or a video camera. The sensors 112 can capture images or other observations and store it on a local memory device (not shown). The UAV copter 100 can also stream the captured images or other observations to a nearby device via a communication device (not shown). In some embodiments, the sensor compartment 104 also includes an inertial measurement unit (which may include accelerometers, gyroscopes, magnetometers, or some combination thereof).

The active components described for the UAV copter 100 may operate individual and independently of other active components. Some or all of the active components can be controlled, partially or in whole, remotely or via an intelligence system (not shown) in the UAV copter 100. The separate active components can be coupled together through one or more communication channels (e.g., wireless or wired channels) to coordinate their operations. Some of all of the active components may be combined as a single component or device. A single component may also be divided into sub-components, each sub-component performing separate functional part of method step(s) of the single component. The UAV copter 100 may include additional, fewer, or different components for various applications.

In some embodiments, the UAV copter 100 has the support structure 106 constructed to be maintained in parallel to the ground surface (e.g., a plane perpendicular to the g-force vector of earth) at steady state flight. Substantially near the outer perimeter of the support structure 106 are the propeller drivers 108 for driving one or more propellers with respective motor shafts of the propeller drivers 108. Each of the propeller drivers 108 can include at least two propellers driven by a motor. Further examples of the UAV copter 100 and the propeller drivers 108 can be found in co-pending U.S. application Ser. No. 15/053,592 (Attorney Docket No. 113427-8004.US01), which is incorporated by reference herein in its entirety.

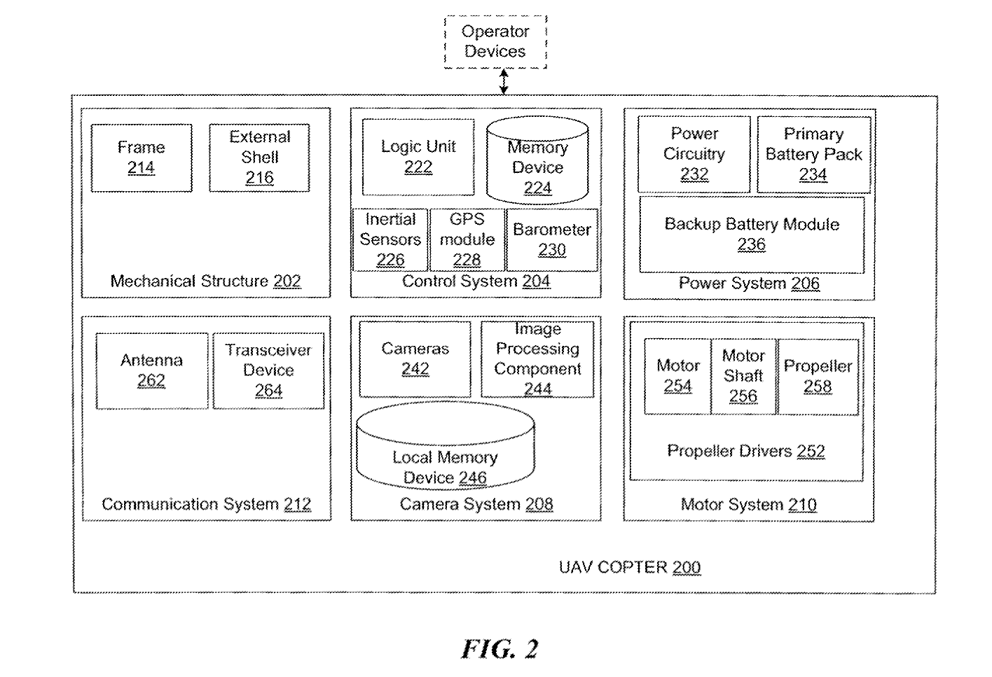

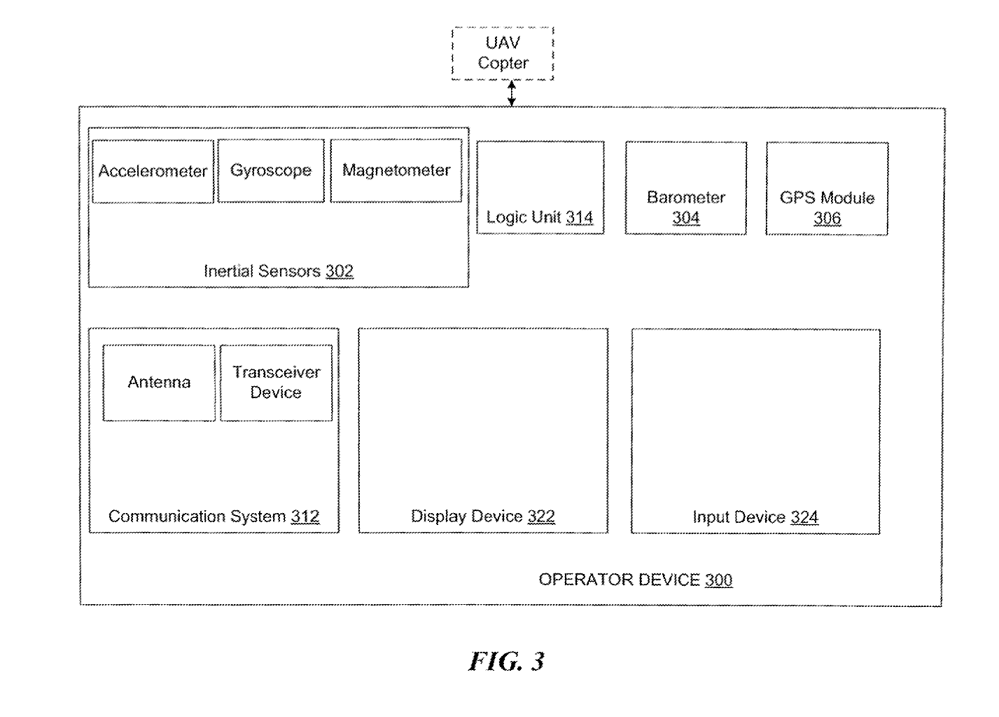

FIG. 2 is a block diagram of a UAV copter 200 (e.g., the UAV copter 100 of FIG. 1), in accordance with various embodiments. The UAV copter 200 includes a mechanical structure 202 (e.g., the support structure 106 of FIG. 1), a control system 204, a power system 206, a camera system 208, a motor system 210, and a communication system 212. The UAV copter 200 can be controlled by one or more operator devices (shown as dashed boxed), For example, the operator devices can be the operator device 300 of FIG. 3. The operator devices can include, for example, a remote control, a mobile device, a wearable device, etc. In some embodiments, one operator device is for tracking the location of the operation, and another operator device is for controlling the UAV copter 200. The operator device for controlling the UAV copter 200 can also be used to supplement the location tracking of the operator.

The mechanical structure 202 includes a frame 214 and an external shell 216. The external shell 216 can include the bottom cover 102 of FIG. 1. The external shell 216 surrounds and protects the UAV copter 200. In various embodiments, the external shell 216 is hermetically sealed to waterproof the UAV copter 200, including sealing the control system 204, and thus prevent liquid (e.g., water) or snow from entering the power system 206 and the communication system 212, when the UAV copter 200 is completely or partially immersed in liquid or snow. While a camera lens of the camera system 208 can be exposed on the external shell 216, the rest of the camera system 208 can also be hermetically sealed within the external shell 216. In some embodiments, only the motor system 210 of the UAV copter 200 is exposed outside of the external shell 216. The motor system 210 can be processed to be waterproof as well, without being sealed within the external shell 216. The above hermetical sealing of component systems of the UAV copter 200 and processing of the motor system 210 advantageously provide a waterproof UAV copter to photo-shoot and take video for athletes participating in adventure sports, such as surfing, sail boating, or snowboarding.

The control system 204 can be implemented as electronic components and/or circuitry including a logic unit 222, such as a processor, an application-specific integrated circuit (ASIC), a field-programmable gate array (FPGA), or any combination thereof. The control system 204 can also include a memory device 224, such as a non-transitory computer-readable storage medium. The memory device 224 can store executable instructions for controlling the UAV copter 200. The executable instructions can be executed by the logic unit 222. The control system 204 can receive instructions remotely from or send information to an operator device via the communication system 212.

The control system 204 can include one or more sensors, such as inertial sensors 226, a global positioning system (GPS) module 228, and a barometer 230. The inertial sensors 226 provide navigational information (e.g., via dead reckoning) including at least one of the position, orientation, and velocity (e.g., direction and speed of movement) of the UAV copter 200. The inertial sensors 226 can include one or more accelerometers (providing motion sensing readings), one or more gyroscopes (providing rotation sensing readings), one or more magnetometers (providing direction sensing), or any combination thereof. The inertial sensors 226 can provide up to three dimensions of readings, such as via 3-axis accelerometer, 3-axis gyroscope, and 3-axis magnetometer. The GPS module 228 can provide three-dimensional coordinate information of the UAV copter 200 via communication with one or more GPS towers, satellites, or stations. The barometer 230 can provide ambient pressure readings used to approximate elevation level (e.g., absolute elevation level) of the UAV copter 200.

The power system 206 includes at least a power circuitry 232, a primary battery pack 234, and a backup battery module 236. When the UAV copter 200 is powered on, the primary battery pack 234 supplies power to the control system 204, the camera system 208, the motor system 210, and the communication system 212, whenever power is needed. The primary battery pack 234 also supplies power to recharge the backup battery module 236. In some embodiments, the backup battery module 236 is embedded within the UAV copter 200 and is not removable or replaceable.

The power circuitry 232 can be configured to regulate the power drawn from the primary battery pack 234. The power circuitry 232 can be configured to monitor the charge level of the primary battery pack 234. The power circuitry 232 can further be configured to detect potential faults and estimate a lifespan of the primary batter pack 234 and/or the backup battery module 236. The power circuitry 232 can be configured to detect a disruption of power from the primary battery pack 234 (e.g., when the primary batter pack 234 is removed from the UAV copter 200 or when the primary battery pack 234 is out of charge). The power circuitry 232 can be configured to detect opening of a battery compartment in the mechanical structure 202. The power circuitry 232 can route power from the backup battery module 236 to the control system 204 upon detecting the disruption of power or the opening of the battery compartment. The backup battery module 236 is able to maintain sufficient charge to power the control system 204 for a short duration, such as 60 seconds. In some embodiments, the backup battery module 236 is only used to power the control system 204 in the absence of the primary battery pack 234, but not to power other systems in the UAV copter 200.

The camera system 208 includes one or more cameras 242 and an image processing component 244. The camera system 208 can include a local memory device 246 to store multimedia observations made by the cameras 242, including photos, audio clips (e.g., from cameras with microphones), and/or videos. The camera system 208 can also have access to the memory device 224. In some embodiments, the local memory device 242 is the memory device 224. The image processing component 244 can be implemented in the form of a processing, an ASIC, a FPGA, or other logical circuitry. The image processing component 244 can be implemented by the logic unit 222 in the control system 204. For example, the image processing component 244 can be implemented as a set of executable instructions stored in the memory device 224. Each of the cameras 242 may include sub-components other than image capturing sensors, including auto-focusing circuitry, International Standards Organization (ISO) adjustment circuitry, shutter speed adjustment circuitry, etc.

The image processing component 244 can be configured to detect obstacles within the UAV copter 200's trajectory. The image processing component 244 can also be configured to detect a target subject, such as the owner of the UAV copter 200. In some embodiments, the image processing component 244 can track multiple target subjects. The image processing component 244 can perform other tasks, such as image filtering, image calling, video frame sampling, and other image processing, audio processing, and/or video processing techniques. The image processing component 244 can also predict the trajectory of the obstacles or the target subject. In some embodiments, an operator device that is expected to be possessed by the target subject can emit certain light or visual signals to render the target subject detectable by the camera system 208 to help locate the target subject.

The motor system 210 includes one or more propeller drivers 252. Each of the propeller drivers 252 includes a motor 254, a motor shaft 256, and a propeller 258. The propeller drivers 252 can be controlled by the control system 204 and powered by the power system 206.

The communication system 212 includes an antenna 262 and a transceiver device 264. The transceiver device 264 can include any of modulators, de-modulators, encoders, decoders, encryption modules, decryption modules, amplifiers, and filters. The communication system 212 can receive control instructions (e.g., navigational mode toggling, trajectory instructions, general settings, etc.) from one of the operator devices. The communication system 212 can send reporting of status of the UAV copter 200 to one of the operator devices. The communication system 212 further enables the camera system 208 to send the multimedia content it captures to one of the operator devices.

The active components described for the UAV copter 100, the UAV copter 200, and/or the operator device 300 may operate individually and independently of other active components. Some or all of the active components can be controlled, partially or in whole, remotely or via an intelligence system in the UAV copter 100, the UAV copter 200, and/or the operator device 300. The separate active components can be coupled together through one or more communication channels (e.g., wireless or wired channels) to coordinate their operations. Some or all of the active components may be combined as one component or device. A single active component may be divided into sub-components, each sub-component performing separate functional part of method step(s) of the single active component. The UAV copter 100, the UAV copter 200, and/or the operator device 300 may include additional, fewer, or different components for various applications.

FIG. 3 is a block diagram of an operator device 300 of a UAV copter (e.g., the UAV copter 100 of FIG. 1 or the UAV copter 200 of FIG. 2), in accordance with various embodiments. The operator device 300 can be a wristband, an ankle band, a ring, a watch, a pendant, a belt, or any other type of wearable device. The operator device 700 can be waterproof (e.g., by sealing the operator device 300 and/or processing electronic circuitry therein to prevent short circuiting from water). The operator device 300 can also be other types of mobile devices, such as a mobile phone, an e-reader, a personal digital assistant (PDA), etc. The operator device 300 can serve at least one or both purposes of controlling the UAV copter and/or providing location information of a target subject for the UAV copter.

The operator device 300, for example, can include one or more inertial sensors 302. The inertial sensors 302 can include at least one of accelerometers (e.g., 3-axis accelerometer), magnetometers (e.g., a 3-axis magnetometer), and gyroscopes (e.g., a 3-axis gyroscope). The operator device 300 can also include a barometer 304. The barometer 304 is used to measure ambient pressure, which is then used to approximate the elevation of the target subject, who is assumed to possess the operator device 300. The operator device 300 can further include a GPS module 306, which can determine the location of the operator device 300. The GPS module 306 can determine the longitude and latitude of the operator device 300 with accuracy when GPS signals are available. The GPS module 306 can also determine the elevation (e.g., a z-axis coordinate) of the operator device 300. In some embodiments, the elevation reading of the GPS module 306 has a lower resolution than the longitude and latitude reading.

The operator device 300 can include a communication module 312 (e.g., including an antenna and a transceiver device). The communication module 312 can wirelessly communicate with the UAV copter via one or more wireless communication protocols, such as WiFi Direct, WiFi, Bluetooth, or other long-range or short-range radio frequency (RF) communication. The operator device 300 can send the sensor readings from the inertial sensors 302, the barometer 304, or the GPS module 306 to the UAV copter.

In some embodiments, the operator device 300 includes a logic unit 314. The logic unit 314 can be a processor, an ASIC, a FPGA, or other electronic circuitry for performing computations. The operator device 300 can also include a memory module 316, such as a non-transitory computer-readable storage medium. The memory module 316 can store executable instructions to configure the logic unit 314 to implement the processes disclosed in this disclosure. For example, the logic unit 314 can process the sensor readings of the inertial sensors 302 to determine coordinates of the operator device 300. In some embodiments, once the coordinates are determined, the coordinates are sent to the UAV copter. In other embodiments, the raw sensor readings are sent to the UAV copter.

In some embodiments, the operator device 300 can include a display device 322 and input device 324. In some embodiments, the display device 322 and the input device 324 can be coupled together, such as a touchscreen display. The display device 322 and the input device 324 can be used to implement a user interface to control and monitor the UAV copter.

### Automatic Video Production

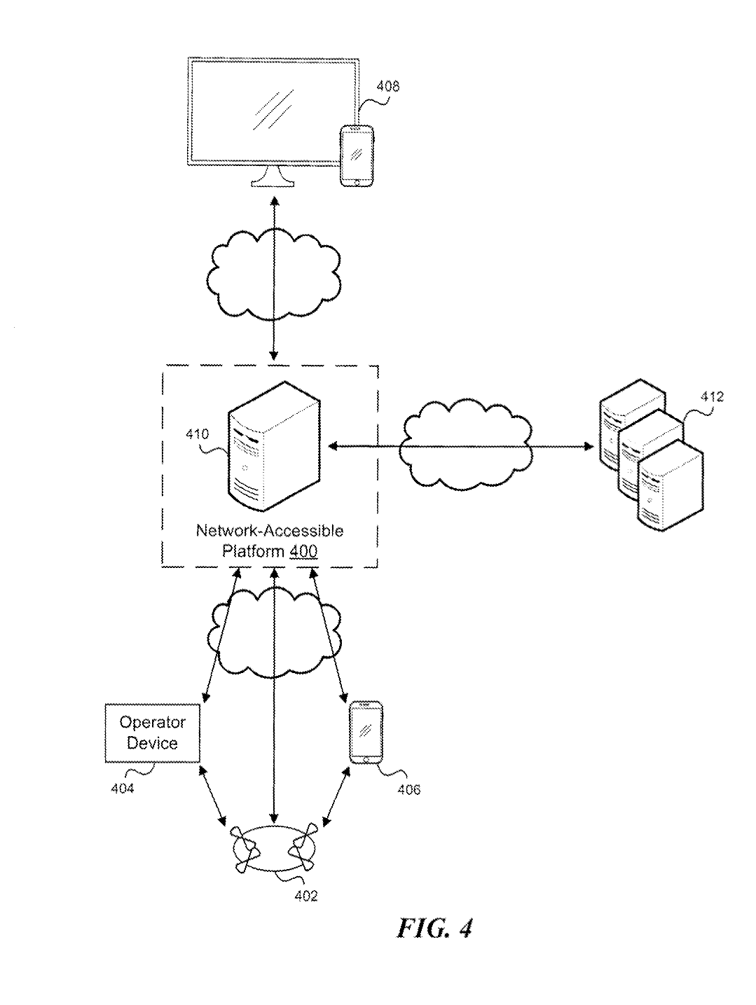

FIG. 4 depicts a diagram of an environment that includes a network-accessible platform 400 that is communicatively coupled to a UAV copter 402, operator device 404, and/or some other computing device 406 associated with the owner/user of the UAV copter 402. Each of these devices can upload streams of data to the network-accessible platform 400, either directly or via the UAV copter 402. The data streams can include, for example, video, audio, user-inputted remote controls, GPS information (e.g., user speed, user path, or landmark-specific or location-specific information), user inertial measurement unit (IMU) activity, flight state of filming device, voice commands, audio intensity, etc. Consequently, the network-accessible platform 400 may receive parallel rich data streams from multiple sources simultaneously or sequentially.

The network-accessible platform 400 may also be communicatively coupled to an editing device 408 (e.g., a mobile phone, tablet, or personal computer) on which an editor views content recorded by the UAV copter 402, operator device 404, and/or the other computing device 406. The editor could be, for example, the same individual as the owner/used of the UAV copter 402 (and, thus, the editing device 408 could be the same computing device as the operator device 404 and/or the other computing device 406). The network-accessible platform 400 is connected to one or more computer networks, which may include local area networks (LANs), wide area networks (WANs), metropolitan area networks (MANs), cellular networks, and/or the Internet.

Various system architectures could be used to build the network-accessible platform 400. Accordingly, the content may be viewable and editable by the editor using the editing device 408 through one or more of a web browser, software program, mobile application, and over-the-top (OTT) application. The network-accessible platform 400 may be executed by cloud computing services operated by, for example, Amazon Web Services (AWS) or a similar technology. Oftentimes, a host server 410 is responsible for supporting the network-accessible platform and generating interfaces (e.g., media editing interfaces and compilation timelines) that can be used by the editor to produce media content (e.g., a video) using several different data streams as input. As further described below, some or all of the production/editing process may be automated by the network-accessible platform 400. For example, media content (e.g., a video) could be automatically produced by the network-accessible platform 400 based on events discovered within sensor data uploaded by the UAV copter 402, operator device 404, and/or other computing device 406.

The host server 410 may be communicatively coupled (e.g., across a network) to one or more servers 412 (or other computing devices) that include media content and other assets (e.g., user information, computing device information, social media credentials). This information may be hosted on the host server 410, the server(s) 412, or distributed across both the host server 410 and the server(s) 412.

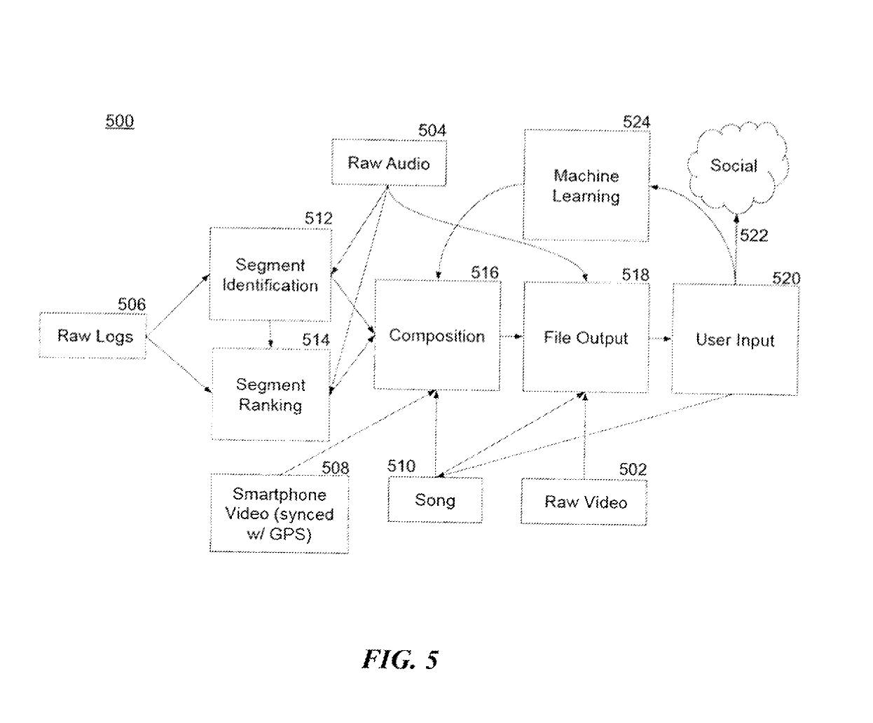

FIG. 5 depicts a flow diagram of a process 500 for automatically producing media content (e.g., a video composition) using several inputs, in accordance with various embodiments. The inputs can include, for example, raw video 502 and/or raw audio 504 uploaded by a UAV copter (e.g., the UAV copter 100 of FIG. 1 or the UAV copter 200 of FIG. 2). It may also be possible for the inputs (e.g., sensor data) to enable the UAV copter to more efficiently index (and then search) the media content it has captured and present identified segments to a user/editor in a stream. Consequently, the network requirements for uploading the identified segments in a long, high-resolution media stream can be significantly reduced.

Raw logs of sensor information 506 can also be uploaded by the UAV copter, operator device, and/or some other computing device. For example, the user's mobile phone may upload video 508 that is synced with GPS information. Other information can also be uploaded to, or retrieved by, a network-accessible platform, including user-inputted remote controls, Global Positioning System (GPS) information (e.g., user speed, user path), inertial measurement unit (IMU) activity, flight state of the filming device, voice commands, audio intensity, etc. In some embodiments, audio 510, such as songs and sound effects, is retrieved by the network-accessible platform (e.g., from server(s) 412 of FIG. 4) for incorporation into the automatically-produced media content.

The importance of each of these inputs can be ranked using one or more criteria. The criteria may be used to identify which input(s) should be used to automatically produce media content on behalf of the user. The criteria can include, for example, camera distance, user speed, camera speed, video stability, tracking accuracy, chronology, and deep learning.

More specifically, raw sensor data 506 uploaded to the network-accessible platform by the UAV copter, operator device, and/or other computing device can be used to automatically identify relevant segments of raw video 502 (step 512). Consequently, media content production/modification may be based on sensor-driven or sensor-recognized events. For example, interesting segments of raw video 502 can be identified based on large changes in acceleration as detected by an accelerometer or large changes in elevation as detected by a barometer. As noted above, the accelerometer and barometer may be connected to (or housed within) the UAV copter, operator device, and/or other computing device. One skilled in the art will recognize that while accelerometers and barometers have been used as examples, other sensors are can be (and often are) used. In some embodiments, the interesting segment(s) of raw video identified by the network-accessible platform are ranked using the criteria discussed above (step 514).

The network-accessible platform can then automatically create a video composition that includes at least some of the interesting segment(s) on behalf of the user of the UAV copter (step 516). For example, the video composition could be created by following different “composition recipes” that allow the style of the video composition to be tailored (e.g., to a certain mood or these) and timed to match certain music and other audio inputs (e.g., sound effects). After production of the video composition is completed, a media file (often a multimedia file) is output for further review and/or modification by the editor (step 518).

In some embodiments, one or more editors guide the production of the video composition by manually changing the “composition recipe” or selecting different audio files or video segments. Some embodiments also enable the editor(s) to take additional steps to modify the video composition (step 520). For example, the editor(s) may be able to reorder interesting segment(s), choose different raw video segments, and utilize video editing tools to modify color, warping, and stabilization.

After the editor(s) have finished making any desired modifications, the video composition is stabilized into its final form. In some embodiments, post-processing techniques can be used on the stabilized video composition, such as dewarping, color correction, etc. The final form of the video composition may be cut, recorded, and/or downscaled for easier sharing on social media (e.g., Facebook, Instagram, and YouTube) (step 522). For example, video compositions may naturally be downscaled to 720p based on a preference previously specified by the editor(s) or the owner/user of the UAV copter.

As video compositions are produced, machine learning techniques can be implemented that allow the network-accessible platform to improve in its ability to automatically create media content (step 524). For example, the network-accessible platform may analyze how different editors compare and rank interesting segment(s) (e.g., by determining why certain identified segments are not considered interesting, or by determining how certain non-identified segments that are considered interesting were missed) to help improve the algorithms used to identify and/or rank interesting segments of raw video using sensor data. Similarly, editor(s) can also reorder interesting segments of video compositions and remove undesired segments to better train the algorithms. Machine learning can be performed offline (e.g., where an editor compares multiple segments and indicates which one is most interesting) or online (e.g., where an editor manually recorders segments within a video composition and removes undesired clips). The results of both offline and online machine learning processes can be used to train a machine learning module executed by the network-accessible platform for ranking and/or composition ordering.

One skilled in the art will recognize that although the process 500 described herein is executed by a network-accessible platform, the same process could also be executed by another computing device, such as a mobile phone, tablet, or personal computer (e.g., laptop or desktop computer).

Moreover, unless contrary to physical possibility, it is envisioned that the steps described above may be performed in various sequences and combinations. For instance, an editor may accept or discard individual segments that are identified as interesting before the video composition is formed. Other steps could also be included in some embodiments.

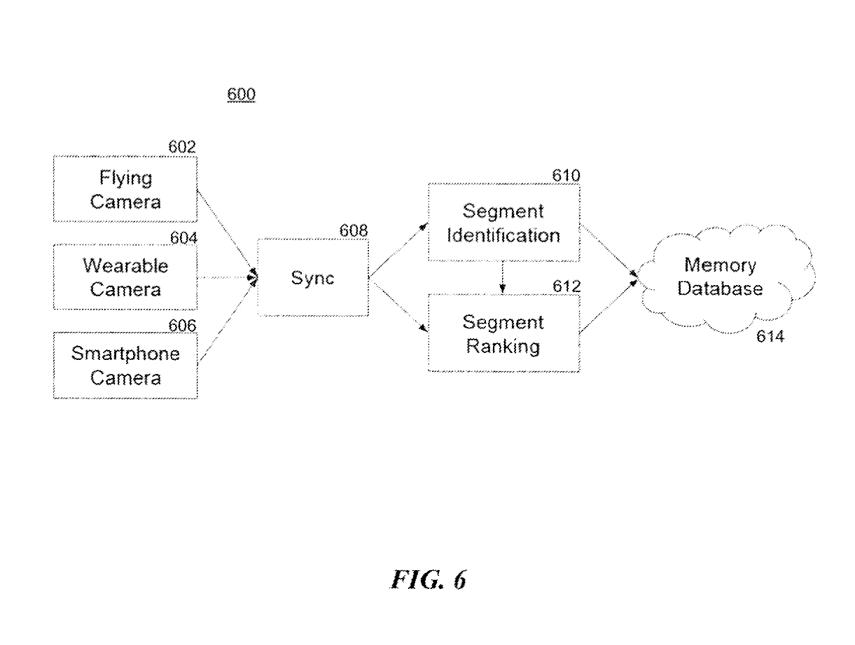

FIG. 6 depicts one example of a process 600 for automatically producing media content (e.g., a video composition) using inputs from several distinct computing devices, in accordance with various embodiments. More specifically, data can be uploaded (e.g., to a network-accessible platform or some other computing device) by a flying camera 602 (i.e., the UAV copter), a wearable camera 604 (e.g., that is part of an operator device), and a smartphone camera 606. The video/image/audio data uploaded by these computing devices may also be accompanied by other data (e.g., sensor data).

In some embodiments, the video/image data uploaded by these computing devices is also synced (step 608). That is, the video/image data uploaded by each source may be temporally aligned (e.g., along a timeline) so that interesting segments of media can be more intelligently cropped and mixed. Temporal alignment permits the identification of interesting segments of a media stream when matched with secondary sensor data streams. Temporal alignment (which may be accomplished by timestamps or tags) may also be utilized in the presentation-time composition of a story. For example, a computing device may compose a story by combining images or video from non-aligned times of a physical location (e.g., as defined by GPS coordinates). However, the computing device may also generate a story based on other videos or photos that are time-aligned, which may be of interest to, or related to, the viewer (e.g., a story that depicts what each member of a family might have been doing within a specific time window).

The remainder of the process 600 may be similar to process 500 of FIG. 5 (e.g., steps 610 and 612 may be substantially similar to steps 512 and 514 of FIG. 5). Note, however, that in some embodiments multiple versions of the video composition may be produced. For example, a high resolution version may be saved to a memory database 614, while a low resolution version may be saved to a temporary storage for uploading to social media (e.g., Facebook, Instagram, or YouTube). The high resolution version may be saved in a location (e.g., a file folder) that also includes some or all of the source material used to create the video composition, such as the video/image data uploaded by the flying camera 602, the wearable camera 604, and/or the smartphone camera 606.

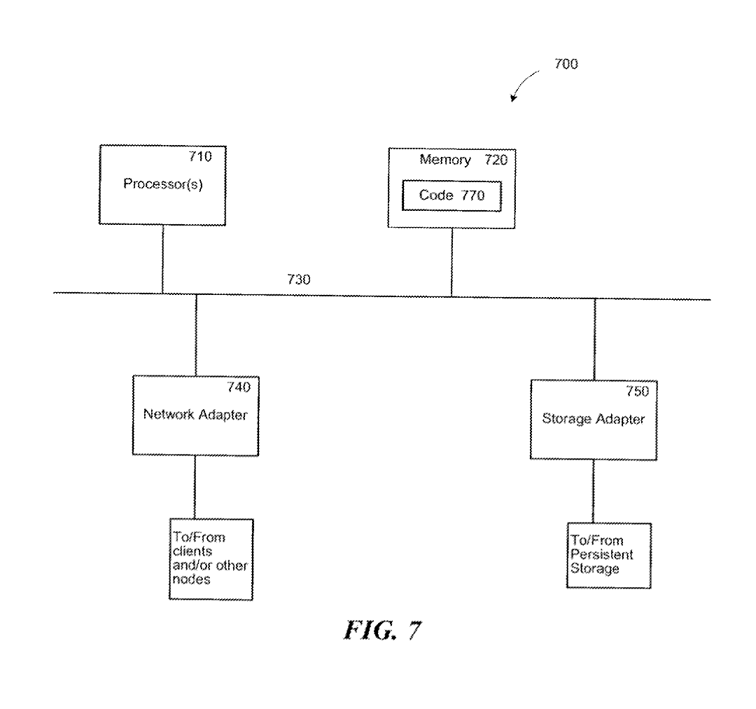

FIG. 7 is a block diagram of an example of a computing device 700, which may represent one or more computing device or server described herein, in accordance with various embodiments. The computing device 700 can represent one of the computers implementing the network-accessible platform 400 of FIG. 4. The computing device 700 includes one or more processors 710 and memory 720 coupled to an interconnect 730. The interconnect 730 shown in FIG. 7 is an abstraction that represents any one or more separate physical buses, point-to-point connections, or both connected by appropriate bridges, adapters, or controllers. The interconnect 730, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

The processor(s) 710 is/are the central processing unit (CPU) of the computing device 700 and thus controls the overall operation of the computing device 700. In certain embodiments, the processor(s) 710 accomplishes this by executing software or firmware stored in memory 720. The processor(s) 710 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 720 is or includes the main memory of the computing device 700. The memory 720 represents any form of random access memory (RAM), read-only memory (ROM), flash memory, or the like, or a combination of such devices. In use, the memory 720 may contain a code 770 containing instructions according to the mesh connection system disclosed herein.

Also connected to the processor(s) 710 through the interconnect 730 are a network adapter 740 and a storage adapter 750. The network adapter 740 provides the computing device 700 with the ability to communicate with remote devices, over a network and may be, for example, an Ethernet adapter or Fibre Channel (FC) adapter. The network adapter 740 may also provide the computing device 700 with the ability to communicate with other computers. The storage adapter 750 allows the computing device 700 to access a persistent storage, and may be, for example, a Fibre Channel (FC) adapter or SCSI adapter.

The code 770 stored in memory 720 may be implemented as software and/or firmware to program the processor(s) 710 to carry out actions described above. In certain embodiments, such software or firmware may be initially provided to the computing device 700 by downloading it from a remote system through the computing device 700 (e.g., via network adapter 740).

The techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic”, as used herein, can include, for example, programmable circuitry programmed with specific software and/or firmware, special-purpose hardwired circuitry, or a combination thereof.

Reference in this specification to “various embodiments” or “some embodiments” means that a particular feature, structure, or characteristic described in connection with the embodiment is included in at least one embodiment of the disclosure. Alternative embodiments (e.g., referenced as “other embodiments”) are not mutually exclusive of other embodiments. Moreover, various features are described which may be exhibited by some embodiments and not by others. Similarly, various requirements are described which may be requirements for some embodiments but not other embodiments.

What is claimed is:

1. A method of producing a video composition from raw video recorded by an unmanned aerial vehicle (UAV) copter, the method comprising:
receiving the raw video from the UAV copter;
receiving a raw log of sensor data from the UAV copter, an operator device, or some other computing device in proximity to the UAV copter;
parsing the raw log of sensor data to identify sensor reading variations that are indicative of interesting real-world events associated with the UAV copter;
modifying a filming characteristic of the UAV copter based on the sensor reading variation;
identifying raw video segments that correspond to the identified sensor reading variations; and
automatically forming a video composition by combining and editing the raw video segments in accordance with a composition recipe.

2. The method of claim 1, further comprising:
presenting a user interface on an editing device associated with an editor; and
enabling the editor to manually modify the video composition.

3. The method of claim 2, wherein the editor is an operator of the UAV copter.

4. The method of claim 2, further comprising:
in response to determining the editor has manually modified the video composition,
applying machine learning techniques to identify modifications made by the editor and, based on the identified modifications, improve one or more algorithms that are used to identify interesting real-world events from the raw log of sensor data.

5. The method of claim 2, further comprising:
downscaling a resolution of the video composition; and
posting the video composition to a social media channel responsive to receiving input at the user interface that is indicative of a request to post the video composition to the social media channel.

6. The method of claim 1, wherein the raw log of sensor data is generated by an accelerometer, gyroscope, magnetometer, barometer, global positioning system (GPS) module, inertial module, or some combination thereof.

7. The method of claim 1, wherein the filming characteristic includes a focal depth, a focal position, a recording resolution, a position of the UAV copter, an orientation of the UAV copter, a movement speed of the UAV copter, or some combination thereof.

8. The method of claim 7, further comprising:
adding audio content to the video composition that conforms with the intended mood or style specified by the composition recipe.

9. A method comprising:
receiving raw video from a first computing device;
receiving a raw log of sensor data from a second computing device,
wherein the raw log of sensor data is generated by a sensor of the second computing device;
parsing the raw log of sensor data to identify sensor measurements that are indicative of interesting real-world events;
identifying raw video segments that correspond to the identified sensor measurements; and
automatically forming a video composition by combining the raw video segments.

10. The method of claim 9, wherein the raw video segments are combined based on chronology or interest level, which is determined based on magnitude of the sensor measurements.

11. The method of claim 9, wherein said parsing comprises:
examining the raw log of sensor data to detect sensor reading variations that exceed a certain threshold during a specified time period; and
flagging the sensor reading variations as representing interesting real-world events.

12. The method of claim 9, wherein the first computing device is an unmanned aerial vehicle (UAV) copter, and wherein the second computing device is an operating device for controlling the UAV copter or a user device associated with a user of the UAV copter.

13. A non-transitory computer-readable storage medium comprising:
executable instructions that, when executed by a processor, are operable to:
receive raw video from an unmanned aerial vehicle (UAV) copter;
receive a raw log of sensor data from the UAV copter, an operator device, or some other computing device in proximity to the UAV copter,
wherein the raw log of sensor data is generated by an accelerometer, gyroscope, magnetometer, barometer, global positioning system (GPS) module, or inertial module housed within the UAV copter;
parse the raw log of sensor data to identify sensor measurements that are indicative of interesting real-world events;
identify raw video segments that correspond to the identified sensor measurements; and
automatically form a video composition by combining the raw video segments.

14. The non-transitory computer-readable storage medium of claim 13, wherein the executable instructions are further operable to:
create a user interface that allows an editor to review the video composition.

15. The non-transitory computer-readable storage medium of claim 14, wherein the executable instructions are further operable to:
downscale a resolution of the video composition; and
post a downscaled version of the video composition to a social media channel responsive to receiving input at the user interface that is indicative of a request to post the video composition to the social media channel.

16. The non-transitory computer-readable storage medium of claim 13, wherein the executable instructions are further operable to:
save the video composition to a memory database.
